(19) United States
(12) Patent Application Publication
(10) Pub. No.: US 2020/0389038 A1
(43) Pub. Date: Dec. 10, 2020

(54) WIRELESS CHARGING SUPPORT FOR INTELLIGENT CLAMPING MOBILE PHONES AND CONTROL METHOD THEREOF

(71) Applicant: SHENZHEN DBK ELECTRONICS CO., LTD., Longhua, Guangdong (CN)

(72) Inventor: Jinhui ZENG, Longhua, Guangdong (CN)

(21) Appl. No.: 16/767,132

(22) PCT Filed: Jul. 19, 2018
(86) PCT No.: PCT/CN2018/096343

§ 371 Date: May 27, 2020

(30) Foreign Application Priority Data
Dec. 29, 2017 (CN) 201721892599.X

(51) Int. Cl. H02J 7/00; H02J 7/02; H02J 50/90; H04M 1/04

(52) U.S. Cl. CPC H02J 7/0044; H04M 1/04; H02J 50/90; H02J 7/02

(57) ABSTRACT

A wireless charging support and a control method thereof are provided. The wireless charging support includes a housing with a cavity. A clamping arm for clamping a mobile phone is disposed on each side of a top of the housing. A supporting portion is disposed at a lower part of the housing. A baffle is disposed at an upper part of the supporting portion. The baffle and a panel are spaced a gap for receiving and clamping the mobile phone. A support clamping mechanism module, a wireless charging module, a general controller, a touch switch and a detection module are disposed in the cavity. The touch switch is disposed at a lower left side of the panel. The detection module is disposed at a lower middle part of the panel and above the baffle. When a user contacts the support, the clamping arm automatically retracts and clamps the mobile phone.

### FIELD

The present application relates to mobile phone supports, and in particular, to a wireless charging support for intelligent clamping mobile phones.

### BACKGROUND

Wireless charging is to use a special device to convert the power from a power socket into rechargeable radio waves, thus to directly charge an electronic equipment without connecting wires. In fact, as early as in 1890, the physicist and electrical engineer Nikola Tesla experimented with wireless power transmission and realized ac power generation. In 2007 a research team of Massachusetts institute of technology (MIT) managed to “catch” electromagnetic waves by applying resonance to electromagnetic wave transmission. Copper coils are used as magnetic resonance device, with one coil attached to a power transmitting end and another coil attached to a power receiving ends. In 2014, computer maker Dell upgraded the technology to realize wireless charging of ultrabooks.

With the development of the wireless charging technology, more and more electronic equipments support wireless charging. Scaffolding wireless charger is one of the electronic equipments supporting wireless charging. The existing common scaffolding chargers can fix a direction of a mobile phone while charging the mobile phone. However those common scaffolding chargers are mechanical clamping arm, if consumers need to take out the mobile phone in the process of charging the mobile phone or place the mobile phone with electricity consumed, the consumers need to manually move a support of the scaffolding chargers to place or take out the mobile device. Those manually moved supports need two hands to operate, which is not convenient for the consumers under sometime conditions, and produces inconvenient user experience.

### SUMMARY

The purpose of this application is to provide a wireless charging support with intelligent control and automatically clamping the mobile phone.

The wireless charging support allows a user to operate it with one hand. When the user needs to charge a mobile phone, the user places the mobile phone on the support, and clamping arms of the support automatically retract and clamp the mobile phone to achieve charging. When the user does not need to charge a mobile phone, the user touch a touch switch, the clamping arms automatically open, and the user can easily take out the mobile phone.

In order to solve the existing problems, the present application provides a wireless charging support for smart clamping mobile phones.

For the above purposes, a technical solution of the present application is that:

a wireless charging support for intelligent clamping mobile phones includes a housing, the housing has a front panel and a rear panel, a cavity is defined in the housing, a clamping arm for clamping a mobile phone is disposed on each side of a top end of the housing, a supporting portion for supporting the mobile phone is disposed at a lower part of the front panel of the housing, a second baffle is disposed at an upper part of the supporting portion, the second baffle and the front panel is spaced a certain gap for receiving and clamping the mobile phone, the front panel is a flat structure; a touch switch is disposed at a lower left side of the front panel, a detection module is disposed at a lower middle part of the front panel and above the second baffle, a support clamping mechanism module, a wireless charging module and a general controller are disposed in the cavity, the general controller is electrically connected to the support clamping mechanism module, the wireless charging module, the detection module and the touch switch respectively.

The support clamping mechanism module is for controlling opening and retraction of the clamping arm.

The wireless charging module is for charging the mobile phone.

The general controller is for controlling and managing the entire system.

The detection module is for detecting a position relationship between the mobile phone and the front panel.

The touch switch is for controlling the opening and retraction of the clamping arm through the support clamping mechanism module.

The wireless charging support for intelligent clamping mobile phones further includes a fixing apparatus for supporting and fixing the housing, the fixing apparatus includes a sucker component for fixing the fixing apparatus and a connecting component disposed on the sucker component for connecting the housing, the connecting component is fixed on an outer side of the rear panel of the housing.

The detection module includes at least one of an ultrasonic sensor, an infrared sensor, a microwave sensor, a microswitch or a pressure sensor.

A control method for a wireless charging support for intelligent clamping mobile phones, the control method for a wireless charging support for intelligent clamping mobile phones includes:

a detection module detecting a mobile phone upon the mobile phone contacting a housing and sending a closing signal to a general controller, the general controller receiving the closing signal and sending instructions to a support clamping mechanism module, the support clamping mechanism module controlling clamping arms to retract to clamp the mobile phone, thereby fixing the mobile phone.

The control method for a wireless charging support for intelligent clamping mobile phones further includes:

a user touching a touch switch when the user needs to take out the mobile phone, the general controller receiving an open signal and sending instructions to the support clamping mechanism module, the support clamping mechanism module controlling the clamping arms to open, the user taking out the mobile phone.

A standby status of the clamping arms of the wireless charging support for intelligent clamping mobile phones is an opening status; or

the detection module not detecting the mobile phone upon the mobile phone far away from the housing, the clamping arms being in a standby status of opening.

When the mobile phone of a user contacts the support, the clamping arms automatically retract and clamp the mobile phone. The touch switch is slightly touched and the clamping arms automatically open, the mobile phone can be taken out for the user's convenience.

### BRIEF DESCRIPTION OF THE DRAWINGS

The following is a detailed explanation of a specific embodiment of the present application in combination with the attached drawings.

FIG. 1 is a schematic view showing a retraction state of clamping arms of the present application;

FIG. 2 is a schematic view showing an open state of the clamping arms of the present application; and

FIG. 3 is an electrical schematic diagram of the present application.

### DETAILED DESCRIPTION OF THE EMBODIMENTS

In order to make the technical problems solved in this application, the technical solutions adopted and the technical effects obtained easy to understand, the specific embodiment of the present application is further explained by combining with the specific attached drawings.

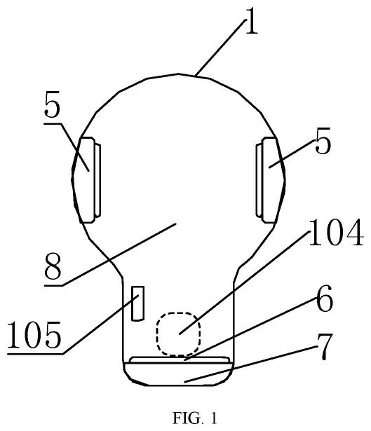

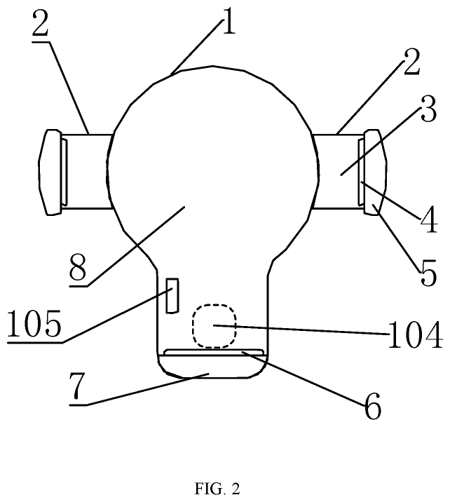

As shown in FIGS. 1 and 2, a mobile phone wireless charging support with ultrasonic intelligent controlling includes a housing 1. The housing 1 has a front panel 8 and a rear panel (not visible in the Figures). The front panel 8 is a flat structure. A cavity (not visible in the Figures) is defined in the housing 1. A clamping arm 2 for clamping a mobile phone is disposed on each side of a top end of the housing 1. A supporting portion 2 for supporting the mobile phone is disposed at a lower part of the front panel 8 of the housing 1. A second baffle 6 is disposed at an upper part of the supporting portion 7. The second baffle 6 and the front panel 8 are spaced a certain gap. The mobile phone can be inserted in the gap. A lower left side of the front panel 8 of the housing 1 is provided with a touch switch 105. A detection module 104 is disposed at a lower middle part of the front panel 8, above the second baffle 6.

The clamping arm 2 includes a back plate 3 and a block 5 connected to an end of the back plate 3 away from the housing 1. A first baffle 4 is disposed at an inner side of the block 5. The first baffle 4 and the back plate 3 are spaced a certain gap. The mobile phone can be inserted in the gap. Another end of the back plate 3 is located in the cavity of the housing 1, and the another end of the back plate 3 is connected with a compression spring or an elastic component so that the clamping arms 2 clamp the mobile phones after retraction.

A support clamping mechanism module 102, a wireless charging module 101 and a general controller 103 are disposed in the cavity of the housing 1.

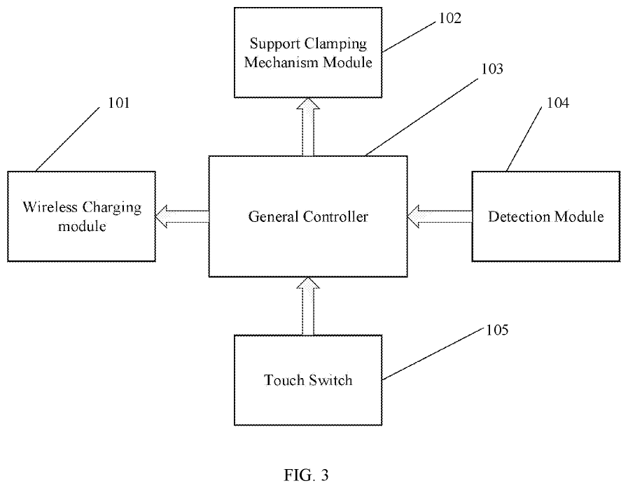

As shown in FIG. 3, the general controller 103 is electrically connected with the support clamping mechanism module 102, the wireless charging module 101, the detection module 104 and the touch switch 105, respectively.

The support clamping mechanism module 102 is for controlling the opening and retraction of the clamping arms 2.

The wireless charging module 101 is for wireless charging the mobile phone.

The general controller 103 is for the control and management of the entire system.

The detection module 104 is for detecting a position relationship between the mobile phone and the front panel 8.

The touch switch 105 is for controlling the opening and retraction of the clamping arms 2 through the support clamping mechanism module 102.

According to specific situations, the support clamping mechanism module 102, the wireless charging module 101, and the general controller 103 can be set on a circuit board, or on two circuit boards, and fixed in the cavity of the housing 1.

In a specific embodiment of the present application, the detection module 104 is an ultrasonic sensor.

As an alternative, the detection module 104 is an infrared sensor.

As an alternative, the detection module 104 is a microwave sensor.

As an alternative, the detection module 104 is a microswitch.

As an alternative, the detection module 104 is a pressure sensor.

Specific Usage:

1. a standby status of the present application is that the clamping arms 2 are opened;

2. when the mobile phone contacts the housing 1, the detection module 104 detects the mobile phone and sends a closing signal to the general controller 103, the general controller 103 receives the closing signal and sends instructions to the support clamping mechanism module 102, the support clamping mechanism module 102 controls the clamping arms to retract to clamp the mobile phone, thereby fixing the mobile phone;

3. when the user needs to take out the mobile phone, the user gently touch the touch switch 105, the general controller 103 receives an open signal and sends instructions to the support clamping mechanism module 102, the support clamping mechanism module 102 controls the clamping arms 2 to open, and the user takes out the mobile phone;

4. when the mobile phone is far away from the housing 1, the detection module 104 cannot detect the mobile phone, and the clamping arms 2 are still in the standby status of opening.

Specifically, the mobile phone wireless charging support with intelligent controlling in the present application also includes a fixing apparatus for supporting and fixing the housing 1. The fixing apparatus includes a sucker component for fixing the fixing apparatus and a connecting component disposed on the sucker component for connecting the housing. The connecting component is fixed on an outer side of the rear panel of the housing.

Described above, the only way for the concrete implementation of this application is better, but the application scope of protection is not limited to, any familiar with this technology in the field of technical personnel, within the scope of this application of technology, according to the technical scheme of this application and inventive concept to equate to replace or change, should be covered within the scope of protection of this application.

The foregoing are only specific embodiments of the present application without limit to the protection scope of the present application, and any equivalent modifications or substitutions obvious to the skilled in the art based on the present disclosure are within the protection scope of the present application.

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present invention without creative efforts shall fall within the protection scope of the present invention.

It is to be understood that, the terms “include” and “comprise” in the present disclosure indicate that the described feature, integrity, step, operation, element and/or subassembly do exist, not excluding the exist or addition of one or plural other feature, integrity, step, operation, element, subassembly and/or the combination thereof.

What is claimed is:

1. A wireless charging support for intelligent clamping mobile phones, wherein the wireless charging support comprises: a housing, the housing having a front panel and a rear panel, a cavity being defined in the housing, a clamping arm for clamping a mobile phone being disposed on each side of a top end of the housing, a supporting portion for supporting the mobile phone being disposed at a lower part of the front panel of the housing, a second baffle being disposed at an upper part of the supporting portion, the second baffle and the front panel being spaced a certain gap for receiving and clamping the mobile phone, the front panel being a flat structure, a touch switch being disposed at a lower left side of the front panel, a detection module being disposed at a lower middle part of the front panel and above the second baffle, a support clamping mechanism module, a wireless charging module and a general controller being disposed in the cavity, the general controller being electrically connected to the support clamping mechanism module, the wireless charging module, the detection module and the touch switch respectively.

2. The wireless charging support for intelligent clamping mobile phones according to claim 1, wherein the clamping arm comprises a back plate and a block connected to an end of the back plate away from the housing, a first baffle is disposed at an inner side of the block, the first baffle and the back plate are spaced a certain gap for receiving and clamping the mobile phone, another end of the back plate is located in the cavity of the housing, and the another end of the back plate is connected with a compression spring or an elastic component.

3. The wireless charging support for intelligent clamping mobile phones according to claim 1, wherein, the support clamping mechanism module is for controlling opening and retraction of the clamping arm.

4. The wireless charging support for intelligent clamping mobile phones according to claim 1, wherein, the detection module is for detecting a position relationship between the mobile phone and the front panel.

5. The wireless charging support for intelligent clamping mobile phones according to claim 1, wherein, the general controller is for controlling and managing the entire system.

6. The wireless charging support for intelligent clamping mobile phones according to claim 1, wherein, the wireless charging support for intelligent clamping mobile phone further comprises a fixing apparatus for supporting and fixing the housing, the fixing apparatus includes a sucker component for fixing the fixing apparatus and a connecting component disposed on the sucker component for connecting the housing, the connecting component is fixed on an outer side of the rear panel of the housing.

7. The wireless charging support for intelligent clamping mobile phones according to claim 3, wherein, the touch switch is for controlling the opening and retraction of the clamping arm through the support clamping mechanism module.

8. The wireless charging support for intelligent clamping mobile phones according to claim 4, wherein, the detection module is an ultrasonic sensor.

9. A control method for a wireless charging support for intelligent clamping mobile phones, wherein, the control method for a wireless charging support for intelligent clamping mobile phones comprises:
a detection module detecting a mobile phone upon the mobile phone contacting a housing and sending a closing signal to a general controller, the general controller receiving the closing signal and sending instructions to a support clamping mechanism module, the support clamping mechanism module controlling clamping arms to retract to clamp the mobile phone, thereby fixing the mobile phone.

10. The control method for a wireless charging support for intelligent clamping mobile phones according to claim 9, wherein, the control method for a wireless charging support for intelligent clamping mobile phone further comprises:
a user touching a touch switch when the user needs to take out the mobile phone, the general controller receiving an open signal and sending instructions to the support clamping mechanism module, the support clamping mechanism module controlling the clamping arms to open, the user taking out the mobile phone.

11. The control method for a wireless charging support for intelligent clamping mobile phones according to claim 9, wherein, a standby status of the clamping arms of the wireless charging support for intelligent clamping mobile phone is an opening status; or
the detection module not detecting the mobile phone upon the mobile phone far away from the housing, the clamping arms being in a standby status of opening.
